(19) United States
(12) Patent Application Publication
(10) Pub. No.: US 2012/0226706 A1
(43) Pub. Date: Sep. 6, 2012

(54) SYSTEM, APPARATUS AND METHOD FOR SORTING MUSIC FILES BASED ON MOODS

(75) Inventors: In Yong CHOI, Suwon-si (KR); Joon Ho WON, Suwon-si (KR); Chul Min CHOI, Seoul (KR); Nam Il LEE, Suwon-si (KR); Sang Hoon OH, Suwon-si (KR)

(73) Assignee: SAMSUNG ELECTRONICS CO. LTD., Suwon-si (KR)

(21) Appl. No.: 13/407,171

(22) Filed: Feb. 28, 2012

(30) Foreign Application Priority Data
Mar. 3, 2011 (KR) 10-2011-0018712

(51) Int. Cl. G06F 17/30

(52) U.S. Cl. 707/752; 707/E17.046

(57) ABSTRACT

A system and method for sorting music files based on moods are provided. The system includes a portable terminal for sorting stored music files based on moods, for changing mood information of a corresponding music file in response to a request to change mood of at least one of the music files, and for transmitting the mood change information to a mood analyzing server, and a mood analyzing server for receiving the mood change information, for updating mood judgment information that is standard information for determining mood of a music file based on the received mood change information, and for transmitting the updated mood judgment information to the portable terminal.

### PRIORITY

This application claims the benefit under 35 U.S.C. §119(a) of a Korean patent application filed on Mar. 3, 2011 in the Korean Intellectual Property Office and assigned Serial No. 10-2011-0018712, the entire disclosure of which is hereby incorporated by reference.

### BACKGROUND OF THE INVENTION

1. Field of the Invention

The present invention relates to a system, an apparatus and a method for sorting music files based on moods. More particularly, the present invention relates to a system, an apparatus and a method for sorting music files based on moods, in which a user can easily change the mood of a music file, which is automatically sorted according to mood judgment information, that is, standard information for determining the mood of a music file, and the mood judgment information can be updated based on a user's feedback for a mood change.

2. Description of the Related Art

With the recent remarkable advancement of information communication technology and semiconductor technology, the popularity and use of portable terminals have been increased rapidly. More particularly, recent portable terminals are reaching a mobile convergence phase covering other terminals' areas as well as respective traditional areas. For example, mobile terminals provide various functions, such as a TV viewing function (e.g., mobile broadcasting, such as Digital Multimedia Broadcasting (DMB) and Digital Video Broadcasting (DVB)), a photographing function, a data communication function, an Internet connection function and a near field communication function, and the like, as well as general communication functions.

With the advancement of memory technologies, the portable terminal now can store thousands of music files. As a large number of songs are stored, a portable terminal user finds it difficult to choose desired songs according to the user's mood. In order to address this problem, a method for analyzing frequency band information, sound pressure information, tempo, and the like, of a music file, for determining the mood of the music file, and for sorting the music file according to the mood is provided. However, in the related art, the method of sorting the music file according to the mood provides only a function of automatically sorting music files according to preset mood judgment information. That is, the method of sorting music files of the related art does not reflect user's personal taste. Furthermore, the method of sorting music files based on moods does not reflect the fact that the same music can be felt differently depending on user's age, gender, nationality, and the like.

Therefore, a need exists for a system, an apparatus and a method for sorting music files based on moods, which provides a user interface through which a user can easily change the mood of an automatically sorted music file according to mood judgment information.

### SUMMARY OF THE INVENTION

Aspects of the present invention are to address at least the above-mentioned problems and/or disadvantages and to provide at least the advantages described below. Accordingly, an aspect of the present invention is to provide a system, an apparatus and a method for sorting music files based on moods, which provides a user interface through which a user can easily change the mood of an automatically sorted music file according to mood judgment information.

Another aspect of the present invention is to provide a system, an apparatus and a method for sorting music files based on moods, which updates mood judgment information reflecting a user's feedback for the mood change of the music files.

Another aspect of the present invention is to provide a system, an apparatus and a method for sorting music files based on moods, which can manage mood judgment information according to user's age, gender, occupation, nationality, and the like.

Another aspect of the present invention is to provide a system, an apparatus and a method for sorting music files based on moods, which can determine the mood of a music file only through meta information without analyzing the music file by accumulating user's feedback information, and mapping meta information of the music file with mood to generate a database.

In accordance with an aspect of the present invention, a system for sorting music files based on moods is provided. The system includes a portable terminal for sorting stored music files based on moods, for changing mood information of a corresponding music file in response to a request to change mood of at least one of the music files, and for transmitting the mood change information to a mood analyzing server, and a mood analyzing server for receiving the mood change information, for updating mood judgment information that is standard information for determining mood of a music file based on the received mood change information, and for transmitting the updated mood judgment information to the portable terminal.

In accordance with another aspect of the present invention, a method for sorting music files based on moods is provided. The method includes sorting stored music files using mood judgment information which is standard information for determining moods of music files, displaying the sorted music files by moods, inputting at least one mood change request among the music files, and changing mood information of the corresponding music file in response to the inputted request, and storing the changed mood information.

In accordance with further another aspect of the present invention, an apparatus for sorting music files based on moods is provided. The apparatus includes a storage unit for storing music files, mood judgment information which is standard information for determining the mood of the music files, and a mood analyzing module for analyzing the moods of the music files and for sorting the music files by moods, a display unit for displaying music files according to the sorted moods, and a controller for changing mood information of the music files in response to at least one mood change request among the music files, and for storing the changed mood information in the storage unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 schematically illustrates a system for sorting music files based on moods according to an exemplary embodiment of the present invention;

FIG. 2A is a block diagram illustrating a configuration of a mood analyzing server according to an exemplary embodiment of the present invention;

FIG. 2B illustrates a mood database classified by groups according to an exemplary embodiment of the present invention;

FIG. 3 is a block diagram schematically illustrating a configuration of a portable terminal according to an exemplary embodiment of the present invention;

FIG. 4 is a flowchart illustrating a signal flow of a system for sorting music files based on moods according to an exemplary embodiment of the present invention;

FIG. 5 is a flowchart illustrating a method of sorting music files of a portable terminal according to an exemplary embodiment of the present invention; and

FIGS. 6 through 8 illustrate screens for explaining a method of sorting music files of a portable terminal according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

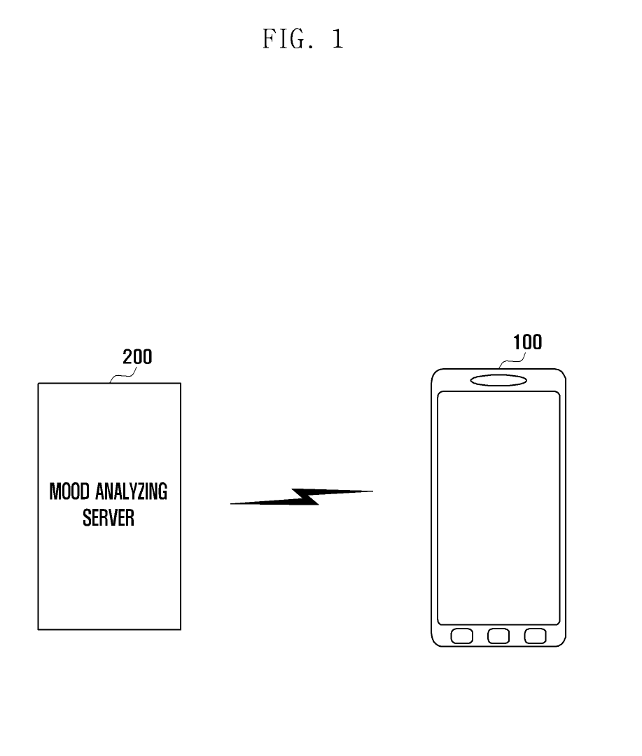

FIGS. 1 through 8, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

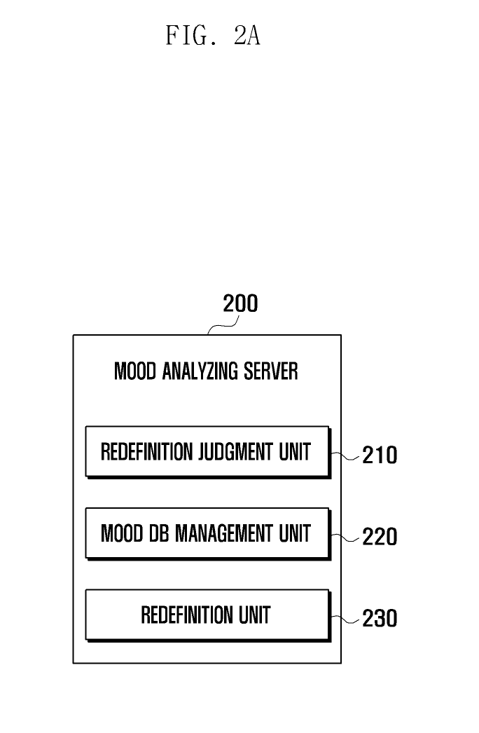

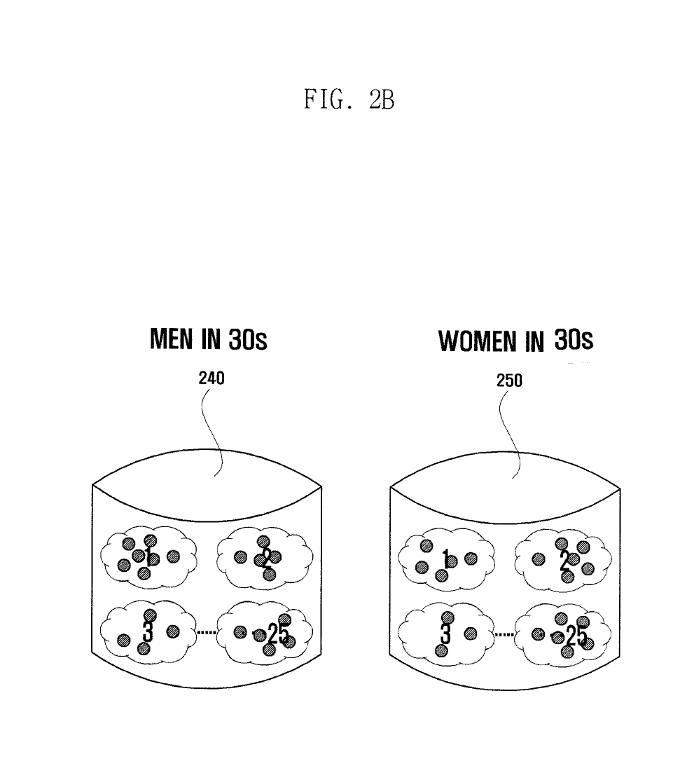

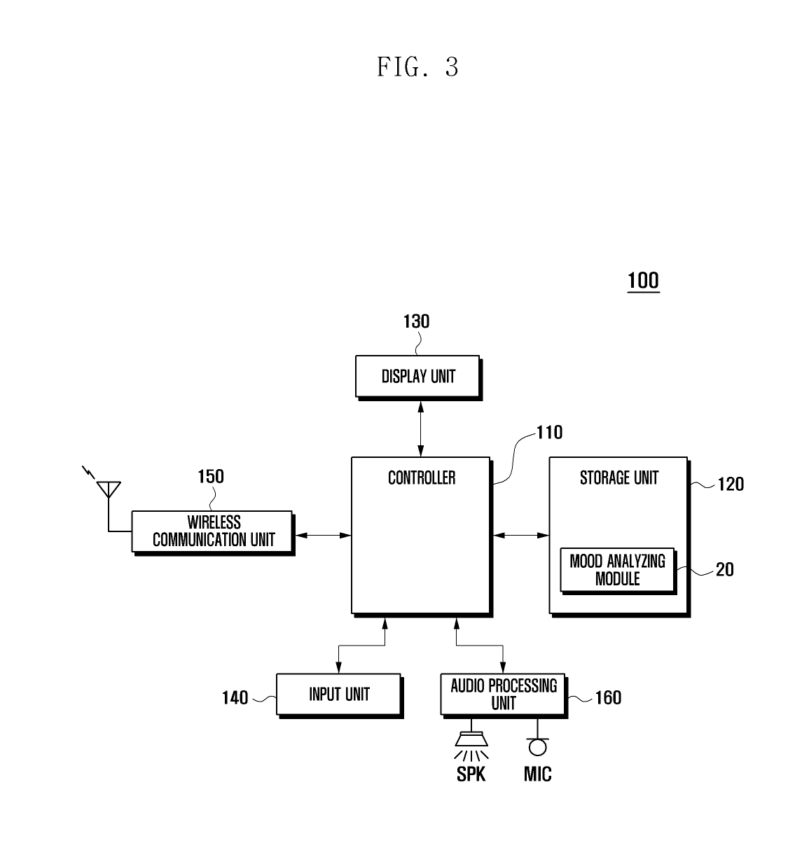

FIG. 1 schematically illustrates a system for sorting music files based on moods according to an exemplary embodiment of the present invention, FIG. 2A is a block diagram illustrating a configuration of a mood analyzing server according to an exemplary embodiment of the present invention, FIG. 2B illustrates a mood database classified by groups according to an exemplary embodiment of the present invention, and FIG. 3 is a block diagram schematically illustrating a configuration of a portable terminal according to an exemplary embodiment of the present invention.

Referring to FIGS. 1 through 3, a system for sorting music files based on moods according to exemplary embodiments of the present invention can include a portable terminal 100 and a mood analyzing server 200.

The mood analyzing server 200 can provide mood judgment information, which is standard information for sorting music files based on moods, to the portable terminal 100. The mood judgment information can include a multiple of parameters, such as a frequency band, sound pressure, tempo, and the like. Furthermore, the mood analyzing server 200 can receive mood change information of a music file by a user from the portable terminal 100, and can update the mood judgment information. The mood analyzing server 200 can be operated by a mobile communication company, a contents provider, and the like. Such a mood analyzing server 200, as illustrated in FIG. 2A, can include redefinition judgment unit 210, a mood database (DB) management unit 220, and a redefinition unit 230.

The redefinition judgment unit 210 can determine whether predefined mood judgment information has been redefined, that is, updated. For example, in the state where mood judgment information has been defined so that a music file having a first pattern is determined as a first mood, when multiple users change the mood of the music file having the first pattern to a second mood, that is, mood change information is received from a multiple of portable terminals, the redefinition judgment unit 210 can request an update of mood judgment information to the redefinition unit 230.

When a redefinition request is received from the redefinition judgment unit 210, the redefinition unit 230 can redefine the mood judgment information using music files (i.e., the whole or in part) mood information received from the user. That is, the redefinition unit 230 can reset parameters for determining the mood of music files. Similarly, exemplary embodiments of the present invention can provide more accurate mood judgment information with which a multiple of users can be satisfied by redefining, that is, updating mood judgment information based on the user's feedback.

The mood DB management unit 220 can generate a database for mood judgment information and can manage the database. At this time, the mood DB management unit 220 can generate a database for mood judgment information classified by groups. For example, as illustrated in FIG. 2B, a mood judgment information database 240 for men in their 30s and a mood judgment information database 250 for women in their 30s can be separately stored. Hence, exemplary embodiments of the present invention can provide mood judgment information that is more appropriate to the user. To this end, it is desirable for the mood analyzing server 200 to receive user information (i.e., age, gender, occupation, nationality, and the like) when receiving the mood change information. Furthermore, the mood DB management unit 220 can store a database which maps the meta information of music files with moods based on mood change information received from the user in order to quickly grasp the mood of music files.

The portable terminal 100 can store a multiple of music files, and can support a music file replay function by moods, which sorts the stored music files based on moods and replays the sorted music files. To this end, the portable terminal 100 can store a mood analyzing module 20 for analyzing the waveform, sound pressure, tempo, and the like, of a music file, and mood judgment information which is standard information for determining the mood of the music. More particularly, the portable terminal 100 supports a function by which the user can change the mood of a music file when it is determined that the mood of the sorted music file is not appropriate. In addition, the portable terminal 100 can transmit mood change information of the music file to the mood analyzing server 200 when the user changes the mood of the music file. Hereinafter, the configuration of each unit of the portable terminal 100 will be explained.

Referring to FIG. 3, the portable terminal 100 can include an audio processing unit 160, a wireless communication unit 150, an input unit 140, a display unit 130, a storage unit 120, and a controller 110. The storage unit 120 can store a mood analyzing module 20.

The audio processing unit 160 can be formed as a sound component which transmits and receives audio signals, and encodes and decodes the audio signals. Such an audio processing unit 160 can include a COder/DECoder (CODEC), an audio amplifier (Amp), and the like. The audio processing unit 160 is connected to a microphone (MIC) and a speaker (SPK). The audio processing unit 160 can convert analog voice signals inputted form the MIC into digital voice signals, generate data for the converted digital voice signals and transmit the data to the controller 110, and can convert digital voice signals inputted from the controller 110 into analog voice signals and output the converted analog voice signals through the SPK. Furthermore, the audio processing unit 160 can output various audio signals generated in the portable terminal 100 through the SPK. For example, the audio processing unit 160 can output audio signals according to a Motion Pictures Expert Group (MPEG-1 or MPEG-2) Audio Layer-3 (MP3) file replay, a moving picture file replay, and the like, through the SPK. More particularly, the audio processing unit 160 can output audio signals according to a music file replay sorted by moods.

The input unit 140 can receive inputted number or various sets of letter information, and can include input keys and function keys for setting various functions and controlling functions of the portable terminal 100. For example, the input unit 140 can include a calling key for a voice call request, a video calling key for a video call request, a termination key for requesting termination of a voice call or a video call, a volume key for adjusting the output volume of an audio signal, a direction key, and the like. More particularly, the input unit 140 can transmit a signal, which is related with a request to replay a music file sorted according to the mood, a request to output a list of music files sorted as the selected mood, and a request to change the mood of the selected music file (e.g., a music file being replayed), to the controller 110. Such an input unit 140 can be formed as one or the combination of input means, such as a touch pad, a touch screen, a button type key pad, a joystick, a wheel key, and the like.

The wireless communication unit 150 can form a communication channel for calling and a communication channel for data transmission. That is, the wireless communication unit 150 can form a voice call channel, a video call channel, a data transmission data, and the like, with a base station. The wireless communication unit 150 can transmit voice signals and video signals to the opponent terminal, or can receive voice signals and video signals from the opponent terminal through the voice call channel and the video call channel under the control of the controller 110. The wireless communication unit 150 can include a wireless frequency transmission unit (not shown) which up-converts and amplifies the frequency of transmitted signals, a wireless frequency reception unit (not shown) which low-noise-amplifies received signals and down-converts the frequency, a transmission-reception separation unit (not shown) which separates received signals and transmitted signals, and the like. More particularly, the wireless communication unit 150 can transmit mood change information to the mood analyzing server 200 when a user changes the mood of a music file. The mood change information can include part of the music file, before-change mood information, and after-change mood information. The mood change information further includes user information, such as gender, age, occupation, nationality, and the like. In addition, the wireless communication unit 150 can receive mood judgment information updated from the mood analyzing server 200 in order to update mood judgment information under the control of the controller 110. When a streaming service is used, the wireless communication unit 150 can receive sound source data. At this time, the wireless communication unit can also receive advertisement data. The advertisement data may be an advertisement for encouraging the purchase of a new music file corresponding to the mood of the currently playing music.

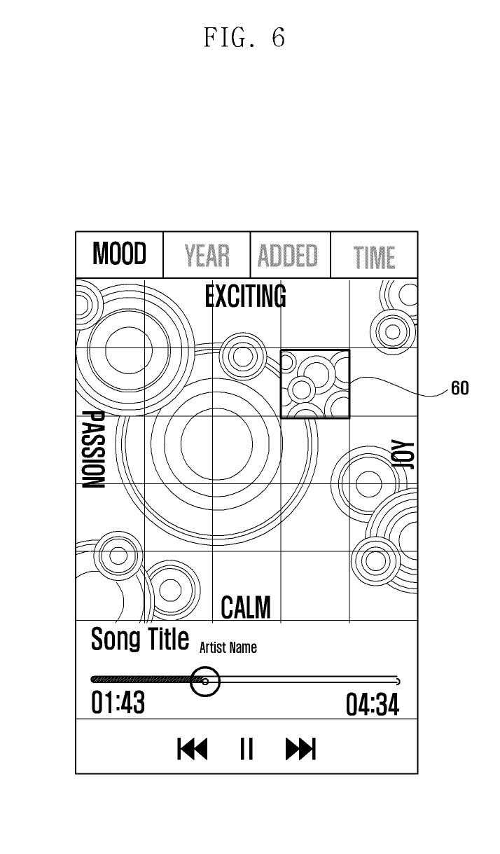

The display unit 130 displays information inputted by the user or information to be provided to the user as well as various menus of the portable terminal 100. For example, the portable terminal 130 can provide various screens according to the use of the portable terminal 100, for example, a standby screen, a message writing screen, a calling screen, and the like. More particularly, the display unit 130 can display a screen of replaying music files sorted based on moods, and a screen of outputting the list of music files sorted as the mood selected among a multiple of moods, which will be explained with reference to FIGS. 6 through 8. The display unit 130 can display an advertisement image received from the mood analyzing server 200 at one end. The display unit 130 can be formed as a Liquid Crystal Display (LCD), an Organic Light Emitting Diode (OLED), an Active Matrix Organic Light Emitting Diode (AMOLED), and the like. Furthermore, when the display unit 130 is formed as a touch screen, the display unit 130 can function as an input unit 140.

The storage unit 120 can store user data as well as programs that are used for operating functions. For example, the storage unit 120 can store a program for controlling general operation of a portable terminal 100, an operating system for booting the portable terminal 100, and an application program, which is required for other optional functions of the portable terminal 100, such as a camera function, a sound replay function, an image or moving picture replay function, a near field communication function, and the like. In addition, the storage unit 120 can store user data generated according to the use of the portable terminal 100, for example, a text message, a game file, a music file, a movie file, and the like. More particularly, the storage unit 120 can store mood judgment information. The mood judgment information can be updated through the mood analyzing server 200. The storage unit 120 can include a mood analyzing module 20 which analyzes a stored music file and determines the mood of the music file using the mood judgment information. The storage unit 120 can store the list of music files according to the mood based on the result of analyzing the mood analyzing module 20. When a user changes the mood of a music file, it is desirable for the storage unit 120 to store the list of the music files by moods with the mood changed by user as the priority. That is, when the user changes the mood of a music file, the storage unit 120 can allow the music file to remain in the mood changed by user even if the mood of the music file is resorted by the mood analyzing module 20. Furthermore, the storage unit 120 can store user information (e.g., age, gender, nationality, occupation, and the like). The user information can be transmitted to the mood analyzing server 200 when the mood of the music file is changed by the user in order to manage mood judgment information according to the group. The user information can be set to be transmitted only when the user allows the transmission.

The controller 110 can control general operation of a portable terminal 100 and a signal flow between internal blocks of the portable terminal 100. More particularly, the controller 110 can analyze the mood of at least one music file stored in the storage unit 120 using the mood analyzing module 20. If a music replay is requested by moods, the controller 110 can output a screen of a music replay by moods to the display unit 130 based on the result of the mood analysis. At this time, the mood can be displayed in two dimensions. For example, when the music file is set to be sorted as 25 moods, the replay screen by moods can be divided by five lines and five rows as illustrated in FIG. 6. At this time, when a touch is inputted by the user, the controller 110 can replay the music file of the corresponding mood (touched mood). When a long touch is inputted, the controller 110 can output the list of music files sorted as the corresponding mood. When a touch movement or drag is inputted, the controller 110 can change the mood of the music file and store the change. The controller 110 can transmit the mood change information of the music file to the mood analyzing server 200. The mood change information can include part of a music file, before-change mood information and after-change mood information. The mood change information can further include user information to the mood judgment information database classified by groups. The controller 110 can control the wireless communication unit 150 to transmit mood information of the music file being replayed to the mood analyzing server 200, and to receive advertisement data that provides information about a new music file corresponding to the mood information of the music file being replayed from the mood analyzing server 200.

Though not illustrated in FIG. 3, the portable terminal 100 can further optionally include components for providing additional functions, such as a camera module for taking images or moving pictures, a broadcast receiving module for receiving a broadcast, a digital sound source replay module (i.e., an MP3 module), a near field communication module for near field communication, a proximity sensor module for proximity detecting, and the like. Because such components can be modified in various manners, all of such components cannot be listed here, but the portable terminal 100 can further include the components of the same level as that of the above mentioned components.

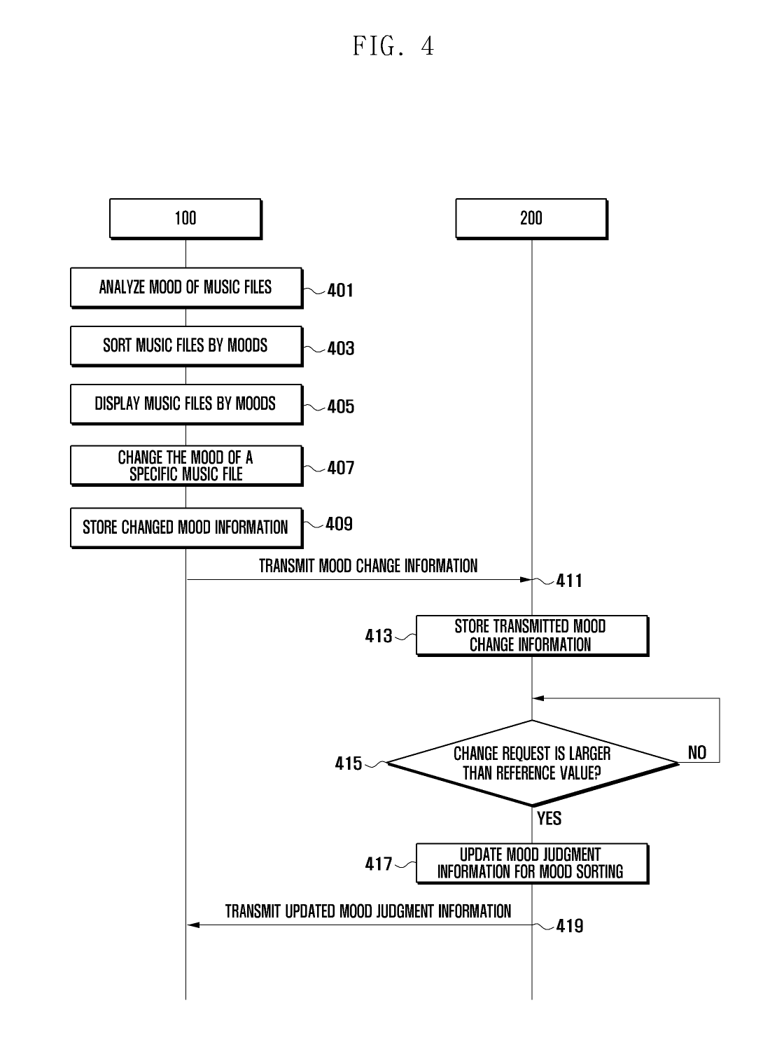

FIG. 4 is a flowchart illustrating a signal flow of a system for sorting music files based on moods according to an exemplary embodiment of the present invention.

Referring to FIG. 4, a portable terminal 100 can analyze the moods of stored music files at step 401. To this end, the portable terminal 100 can store mood judgment information, which is standard information for determining the moods of music files. In addition, the portable terminal 100 can analyze music files, and include a mood analyzing module 20 that compares music files with the mood judgment information and determines the moods of the music files. The portable terminal 100 can sort music files based on the result of the analysis at step 403, and store the list of music files by moods.

Thereafter, the portable terminal 100 can output a user interface screen which displays music files sorted by moods in response to a user's request at step 405. For example, when music files are sorted by 25 moods, the portable terminal 100 can display moods in two dimensions of 5 lines and 5 rows.

The portable terminal 100 can change the mood of the selected music file at step 407. The mood change can be achieved in a drag and drop method. For example, in a user interface screen displayed in 5 lines and 5 rows in order to change the mood, in the state where the cell corresponding to the mood of the selected music file is touched, the user can drag to the cell of a desired mood and release (drop) the touch. Such a user interface screen will be explained with reference to FIGS. 6 through 8.

If the mood of the selected music file is changed, the portable terminal 100 can store changed mood information at step 409, and transmit the mood change information to the mood analyzing server 200 at step 411. The mood change information can include part of the selected music file, before-change mood information, and after-change mood information. The mood change information can further include user information (e.g., age, gender, occupation, nationality, and the like). The user can set whether the user information will be transmitted through the menu. The user information is used for separately managing mood judgment information classified by groups as explained above with reference to FIG. 2B. The mood judgment information is separately managed because the user can feel differently for the same music depending on his or her age, occupation, gender, nationality, and the like.

The mood analyzing server 200, which receives the transmitted mood change information, stores the transmitted mood change information at step 413. The mood analyzing server 200 can determine whether the mood change request exceeds a preset reference value at step 415. When the mood change request does not exceed the reference value, the mood analyzing server 200 remains at step 415. In contrast, when the mood change request exceeds the reference value, the mood analyzing server 200 can update the mood judgment information for sorting music files based on moods at step 417, and transmit updated mood judgment information to the portable terminal 100 at step 419. That is, when multiple users change the mood of a music file having the first pattern from the first mood to the second mood, the mood analyzing server 200 can update the mood judgment information so that the music file having the first pattern can be sorted as the second mood, and transmit the updated mood judgment information to the portable terminal 100.

Though not illustrated, the mood analyzing server 200 can generate a meta mood database (DB) through mapping meta information of music files with moods by utilizing mood change information received from users. Through the meta mood database, the mood analyzing server 200 can quickly determine the mood of the music file using only meta information of the music file (i.e., title, singer, year, and the like) without analyzing the music file.

The mood analyzing server 200 can provide a real-time music replay service (e.g., a streaming service). At this time, the mood analyzing server 200 can receive mood information of the music file being replayed, which is selected by the user, from the portable terminal 200, and provide music files corresponding to the received mood information in real time. In addition, the mood analyzing server 200 can transmit advertisement data, which provides information about new music files (i.e., new songs) corresponding to received moods, for example, advertisement data for encouraging the purchase, to the portable terminal 100.

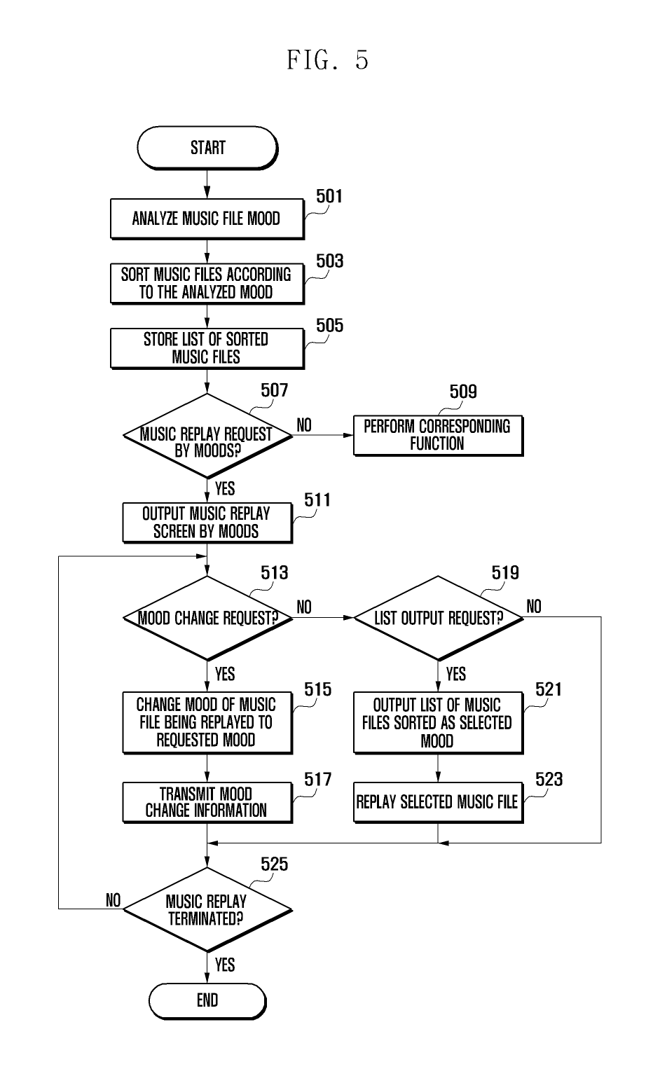

FIG. 5 is a flowchart illustrating a method of sorting music files of a portable terminal according to an exemplary embodiment of the present invention, and FIGS. 6 through 8 illustrate screens for explaining a method of sorting music files of a portable terminal according to exemplary embodiments of the present invention.

Referring to FIGS. 5 through 8, the controller 110 can analyze the mood of at least one music file stored in the storage unit 120 using the mood analyzing module 20 at step 501. To this end, the storage unit 120 can store mood judgment information, which is standard information for determining the mood of a music file. The controller 110 can sort music files by moods based on the result of the analysis at step 503, and store the list of music files by moods in the storage unit 120 at step 505.

Thereafter, the controller 110 can determine whether a music replay request by moods is inputted at step 507. If the music replay request by moods is not inputted, the controller 110 can perform the corresponding function at step 509. For example, the controller 110 can replay the stored entire music files in consecutive order, perform a photographing function or a moving picture replay function, or the like. In contrast, if the music replay request by moods is inputted, the controller 110 can output a music replay screen by moods at step 511. For example, the controller 110 can output a music replay screen by moods in the display unit 130, as illustrated in FIG. 6. Referring to FIG. 6, it is assumed that the music files are sorted as 25 moods. The music replay screen by moods is divided by cells of 5 lines and 5 rows. The replay screen by moods can display keywords representing moods at right & left and upper & lower sides so that the user can intuitively recognize the mood. That is, in the replay screen by moods, the cell at the upper side has an “exciting” mood, the cell at the lower side has a “calm” mood, the cell at the left side has a “passion” mood, and the cell at the right side has a “joy” mood. The key words can be changed. Therefore, the user can easily select the music of desired mood. That is, if the user selects one of the 25 cells by touching the cell, the controller 110 replays music files corresponding to the mood in consecutive order. At this time, the controller 110 can display selected cell 60 in such a manner that the selected cell 60 are visually distinguished from other cells.

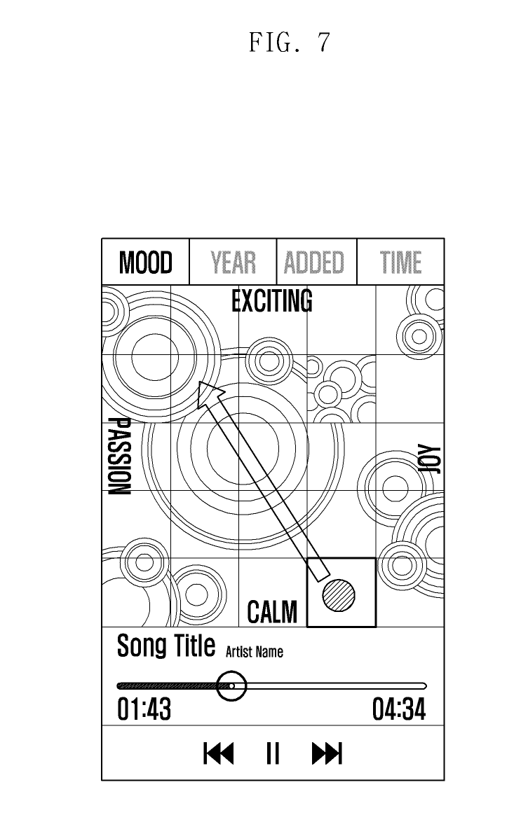

Thereafter, the controller 110 can determine whether a mood change request is inputted at step 513. The mood change request can be made in a drag & drop method in the music replay screen by moods. For example, as illustrated in FIG. 7, when it is determined that the mood of music being replayed is not appropriate, the user can touch the corresponding cell (i.e., the cell positioned at fifth line and fourth row), drag to a cell in which the user feels appropriate (i.e., the cell positioned at second line and second row), and release (drop) the touch.

If it is determined at step 513 that the mood change request is inputted, the controller 110 can change the list of music files by moods so that the music file being replayed belongs to the requested (moved) mood, and store the changed list at step 515. Thereafter, the controller 110 can transmit the mood change information to the mood analyzing server 200 at step 517. At this time, the mood change information can include part of the selected music files, before-change mood information, and after-change mood information. The mood change information can further include user information (e.g., age, gender, occupation, nationality, and the like). A user can set whether to transmit the user information through the menu. When an exemplary embodiment of the present invention is not linked with the mood analyzing server 200, step 517 can be omitted.

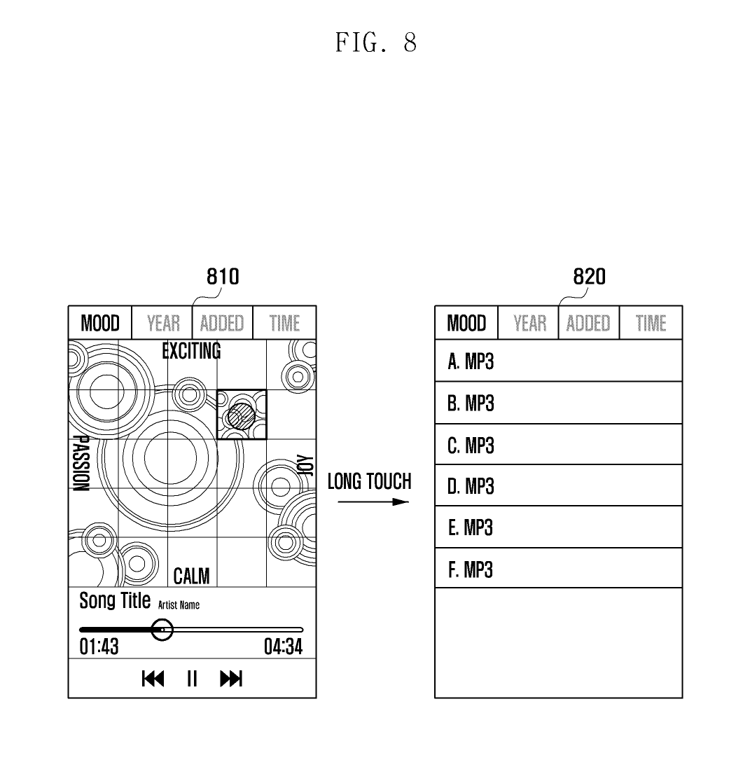

In contrast, if it is determined at step 513 that a mood change request is not inputted, the controller 110 can determine whether a list output request is inputted at step 519. If it is determined at step 519 that the list output request is not inputted, the controller 110 proceeds to step 525 which will be explained below. In contrast, if it is determined at step 519 that the list output request is inputted, the controller 110 can output the list of music files sorted as the selected moods at step 521. For example, as illustrated in a screen example of reference numeral 810 of FIG. 8, if the user touches the cell positioned at second line and second row for more than a preset period of time, that is, long-touches the cell, the controller 110 can output the list of music files sorted as the mood corresponding to the cell as illustrated in a screen example of reference numeral 820.

Thereafter, the controller 110 can replay the music files selected by the user from the list at step 523, through which the user can change the music files and change the mood of the change music files. The controller 110 determines whether a music replay termination request is inputted at step 525. If it is determined at step 525 that the music replay termination request is inputted, the controller 110 terminates the replay of music files by moods. In contrast, if it is determined at step 525 that the music replay termination request is not inputted, the controller 110 can perform the above-described process by returning to step 513.

In the above exemplary implementation, it was explained that the mood is changed while the music is replayed by moods, but exemplary embodiments of the present invention are not limited to such an explanation. For example, exemplary embodiments of the present invention can change the mood of the music file even in the state where the music replay is stopped.

The method of sorting music files may be implemented in an executable program command form by various computer means and be recorded in a computer readable recording medium. In this case, the computer readable recording medium may include a program command, a data file, and a data structure individually or a combination thereof. In the meantime, the program command recorded in a recording medium may be specially designed or configured for exemplary embodiments of the present invention or be known to a person having ordinary skill in a computer software field to be used.

The computer readable recording medium includes Magnetic Media, such as a hard disk, a floppy disk, or a magnetic tape, an Optical Media, such as a Compact Disc Read Only Memory (CD-ROM) or a Digital Versatile Disc (DVD), a Magneto-Optical Media, such as a floptical disk, and a hardware device, such as a ROM, a Random Access Memory (RAM), a flash memory for storing and executing program commands. The program command includes a machine language code created by a complier and a high-level language code executable by a computer using an interpreter. The foregoing hardware device may be configured to be operated as at least one software module to perform an operation of the present invention.

According to a system, an apparatus, and a method for sorting music files based on moods according to an exemplary embodiment of the present invention, a user can easily change the mood of a music file automatically sorted by a mood sorting algorithm of music files. Moreover, exemplary embodiments of the present invention can provide more general and accurate mood judgment information as the mood judgment information is updated reflecting a user's mood change information for a music file. In addition, exemplary embodiments of the present invention can provide more appropriate mood judgment information to a user as the mood judgment information is managed by groups. According to exemplary embodiments of the present invention, mood can be quickly determined only using meta information of a music file without analyzing the mood of the music file as a user's feedback information for the mood of music files is accumulated and is made as a database. Furthermore, according to an exemplary embodiment of the present invention, when an advertisement function for encouraging the purchase of music files is performed, consumers can be more encouraged to purchase the music files as the music file information is provided based on the mood judgment information reflecting a user's taste.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A system for sorting music files based on moods, the system comprising:
a portable terminal for sorting stored music files based on moods, for changing mood information of a corresponding music file in response to a request to change mood of at least one of the music files, and for transmitting the mood change information to a mood analyzing server; and
a mood analyzing server for receiving the mood change information, for updating mood judgment information that is standard information for determining mood of a music file based on the received mood change information, and for transmitting the updated mood judgment information to the portable terminal.

2. The system of claim 1, wherein the mood change information includes part of the mood-changed music file, before-change mood, and after-change mood.

3. The system of claim 2, wherein the mood change information further includes user information including at least one of age, gender and nationality.

4. The system of claim 3, wherein the mood analyzing server updates the mood judgment information by dividing groups based on the user information.

5. The system of claim 1, wherein the mood analyzing server receives information of moods being replayed from the portable terminal, and transmits advertisement data, which provides information about a new music file corresponding to the mood being replayed by the portable terminal, to the portable terminal.

6. The system of claim 1, wherein the mood analyzing server includes a redefinition judgment unit for determining whether the mood judgment information is redefined; and a redefinition unit for redefining the mood judgment information based on the mood change information.

7. The system of claim 6, further comprising:
a mood database management unit for generating a database for mood judgment information, and for managing the database.

8. The system of claim 7, wherein the mood database management unit generates a meta-mood database by mapping the meta information of the music file with moods based on the mood change information received from the portable terminal and the meta information of the music file.

9. A method for sorting music files based on moods, the method comprising:
sorting stored music files based on mood judgment information which is standard information for determining moods of music files;
displaying the sorted music files by moods;
inputting at least one mood change request among the music files; and
changing mood information of the corresponding music file in response to the inputted request, and storing the changed mood information.

10. The method of claim 9, further comprising:
transmitting mood change information including part of the mood-changed music file, before-change mood and after-change mood to a mood analyzing server.

11. The method of claim 10, wherein the transmitting of the mood change information to a mood analyzing server further comprises:
transmitting user information including at least one of age, gender and nationality.

12. The method of claim 10, further comprising:
updating the mood judgment information in the mood analyzing server based on the transmitted mood change information.

13. The method of claim 12, wherein the updating of the mood judgment information further comprises:
updating mood judgment information classified by groups based on user information.

14. The method of claim 9, wherein the inputting of the at least one mood change request comprises:
touching a cell where a music file, whose mood change is desired, is positioned; and
moving the touch to a cell corresponding to a desired mood and releasing the touch.

15. An apparatus for sorting music files based on moods, the apparatus comprising:
a storage unit for storing music files, mood judgment information which is standard information for determining the mood of the music files, and a mood analyzing module for analyzing the moods of the music files and for sorting the music files by moods;
a display unit for displaying music files according to the sorted moods; and
a controller for changing mood information of the music files in response to at least one mood change request among the music files, and for storing the changed mood information in the storage unit.

16. The apparatus of claim 15, further comprising:
a wireless communication unit for transmitting mood change information including part of the mood-changed music files, before-change mood and after-change mood to the mood analyzing server.

17. The apparatus of claim 16, wherein the wireless communication unit further transmits user information including at least one of age, gender and nationality to the mood analyzing server.

18. The apparatus of claim 16, wherein the wireless communication unit receives mood judgment information updated based on the transmitted mood change information from the mood analyzing server.

19. The apparatus of claim 16, wherein the controller controls the wireless communication unit to transmit mood information of a music file being replayed to the mood analyzing server, and to receive advertisement data, which provides information about a new music file corresponding to the mood information of the music file being replayed, from the mood analyzing server.

20. The apparatus of claim 15, wherein the display unit is formed as a touch screen, and the sorted moods are divided in cells of a multiple of lines and a multiple of rows and are displayed, and wherein the controller changes the mood of a music file to the mood corresponding to the cell from which the touch is released when the touch is released after the touch generated in one of the cells of the multiple of lines and the multiple of rows is moved to another cell.
